(19) United States
(12) Patent Application Publication
(10) Pub. No.: US 2026/0211495 A1
(43) Pub. Date: Jul. 23, 2026

(54) OPERATING DEVICE, INFORMATION PROCESSING DEVICE, INFORMATION PROCESSING SYSTEM, INFORMATION PROCESSING METHOD, AND INFORMATION PROCESSING PROGRAM

(71) Applicant: Sony Interactive Entertainment Inc., Tokyo (JP)

(72) Inventor: Takuya Kuji, Tokyo (JP)

(73) Assignee: Sony Interactive Entertainment Inc., Tokyo (JP)

(21) Appl. No.: 19/140,274

(22) PCT Filed: Jan. 6, 2023
(86) PCT No.: PCT/JP2023/000179

§ 371 Date: Jun. 17, 2025

(51) Int. Cl. G06F 3/01; G06T 7/73; G06T 17/00

(52) U.S. Cl. CPC G06F 3/014; G06T 7/73; G06T 17/00; G06T 2207/30196

(57) ABSTRACT

An operation apparatus (10) includes a mounting section that is mounted to a body of a detection target, a plurality of imaging sections (11A, 11B, 11C, 11D, 11E, and 11F) that are provided in the mounting section and are arranged at positions corresponding to at least either joint parts or distal end parts of the body, and an output section (12) that outputs a plurality of images generated by the plurality of imaging sections.

### TECHNICAL FIELD

The present invention relates to an operation apparatus, an information processing apparatus, an information processing system, an information processing method, and an information processing program.

### BACKGROUND ART

For the purpose of utilization in virtual reality (VR) and the like, a technique for tracking the movement of hands and fingers of a user has been known from the past (for example, see NPL 1).

In the invention described in NPL 1, alternating current magnetic field generation apparatuses are provided at positions corresponding to the backs of hands, and magnetic sensors (receivers) are provided at fingertips, to detect the positions and the postures of the fingertips of the user.

### CITATION LIST

### Non Patent Literature

[NPL 1]
Introduction home page of Quantum Metagloves (Manus VR Inc.) (https://www. ask-corp.jp/products/manus-vr/vr-device/quantum-metagloves.html)

### SUMMARY

### Technical Problem

While the apparatus of NPL 1 can track the fingertips of the user by detecting the positions relative to the alternating current magnetic field generation apparatuses, it cannot detect the positions of the hands and fingers themselves of the user. Therefore, a configuration for detecting the positions of the hands and fingers themselves of the user is further required. For example, it is conceivable to detect the positions of the hands and fingers themselves of the user on the basis of images obtained by imaging the user by the third person viewpoint of the user, what is generally called “outside-in,” from the outside. However, in such a method, in addition to necessity of installation of an imaging apparatus capable of imaging from the third person viewpoint of the user, a problem of occlusion such as overlapping of the hands and fingers with the body may occur.

### Solution to Problem

An operation apparatus according to a first aspect of the present invention includes a mounting section that is mounted to a body of a detection target, a plurality of imaging sections that are provided in the mounting section and are arranged at positions corresponding to at least either joint parts or distal end parts of the body, and an output section that outputs a plurality of images generated by the plurality of imaging sections.

An information processing apparatus according to a second aspect of the present invention includes an acquisition section that acquires a plurality of images generated by an operation apparatus including a plurality of imaging sections arranged at positions corresponding to at least either joint parts or distal end parts of a body and an estimation section that estimates a position and a posture of each of the plurality of imaging sections on the basis of the plurality of images.

An information processing system according to a third aspect of the present invention includes an operation apparatus that includes a plurality of imaging sections arranged at positions corresponding to at least either joint parts or distal end parts of a body and the above-described information processing apparatus.

An information processing method according to a fourth aspect of the present invention includes an acquisition procedure of acquiring a plurality of images generated by an operation apparatus including a plurality of imaging sections arranged at positions corresponding to at least either joint parts or distal end parts of a body and an estimation procedure of estimating a position and a posture of each of the plurality of imaging sections on the basis of the plurality of images.

An information processing program according to a fifth aspect of the present invention causes a computer to execute an acquisition step of acquiring a plurality of images generated by an operation apparatus including a plurality of imaging sections arranged at positions corresponding to at least either joint parts or distal end parts of a body and an estimation step of estimating a position and a posture of each of the plurality of imaging sections on the basis of the plurality of images.

### BRIEF DESCRIPTION OF DRAWINGS

FIG. 1 is a schematic diagram for depicting an outline configuration of an information processing system according to a first embodiment.

FIG. 2A is a diagram for schematically depicting an operation apparatus according to the first embodiment.

FIG. 2B is another diagram for schematically depicting the operation apparatus according to the first embodiment.

FIG. 3A is another diagram for schematically depicting the operation apparatus according to the first embodiment.

FIG. 3B is another diagram for schematically depicting the operation apparatus according to the first embodiment.

FIG. 4 is another diagram for schematically depicting the operation apparatus according to the first embodiment.

FIG. 5 is another diagram for schematically depicting the operation apparatus according to the first embodiment.

FIG. 6A is another diagram for schematically depicting the operation apparatus according to the first embodiment.

FIG. 6B is another diagram for schematically depicting the operation apparatus according to the first embodiment.

FIG. 7 is a diagram for depicting an example of feature points based on a reference image.

FIG. 8A is a diagram for explaining adjustment of a three-dimensional (3D) model.

FIG. 8B is another diagram for explaining adjustment of the 3D model.

FIG. 9 is a flowchart for depicting an example of a processing method according to the first embodiment.

FIG. 10 is a diagram for explaining an apparatus operated according to an operation on an operation apparatus according to a second embodiment.

FIG. 11 is a schematic diagram for depicting an outline configuration of an information processing system according to the second embodiment.

FIG. 12 is a flowchart for depicting an example of a processing method according to the second embodiment.

FIG. 13 is a diagram for schematically depicting an operation apparatus according to a modified example.

### DESCRIPTION OF EMBODIMENTS

### First Embodiment

Hereinafter, a first embodiment of the present invention will be described on the basis of the drawings.

### Outline Configuration of Information Processing System

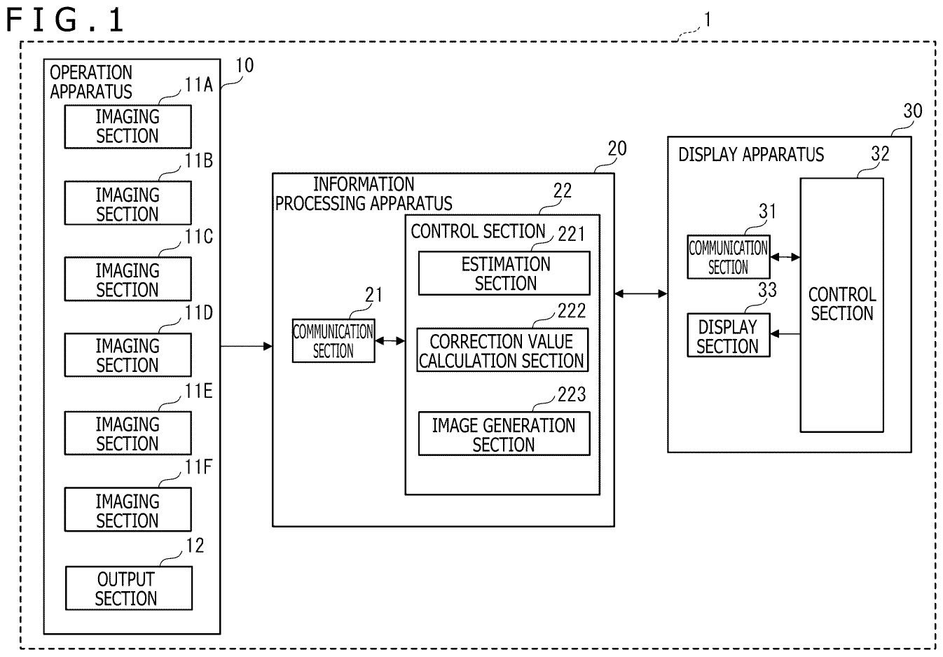

FIG. 1 is a schematic diagram for depicting an outline configuration of an information processing system according to the first embodiment.

As depicted in FIG. 1, an information processing system 1 according to the first embodiment includes an operation apparatus 10, an information processing apparatus 20, and a display apparatus 30. The information processing system 1 allows the information processing apparatus 20 to generate a model image (reproduction image) reproducing hands and fingers of a user in a virtual space, according to an operation on the operation apparatus 10, and displays the model image (reproduction image) on the display apparatus 30.

### Configuration of Operation Apparatus

The operation apparatus 10 includes imaging sections 11A, 11B, 11C, 11D, 11E, and 11F and an output section 12, and accepts an operation performed by the user. The imaging sections 11A to 11F are arranged at positions corresponding to at least either joint parts or distal end parts of the hands and the fingers of the user, and each generate an image. The output section 12 outputs the images generated by the imaging sections 11A to 11F to the outside of the operation apparatus 10 via wireless or wired communication.

The operation apparatus 10 is mounted to the hands and the fingers of the user by a mounting section that is not illustrated. The mounting section includes, for example, a glove-shaped mounting member. The mounting member may include a material that can adhere to the hand of the user and that can be stretched or contracted, or may be in a band shape. In addition, the operation apparatus 10 may be what is generally called an exoskeleton controller.

The imaging sections 11A to 11F of the operation apparatus 10 include lenses, which are not illustrated, provided for the respective fingers and respective sensors 111a, 111b, 111c, 111d, 111e, and 111f.

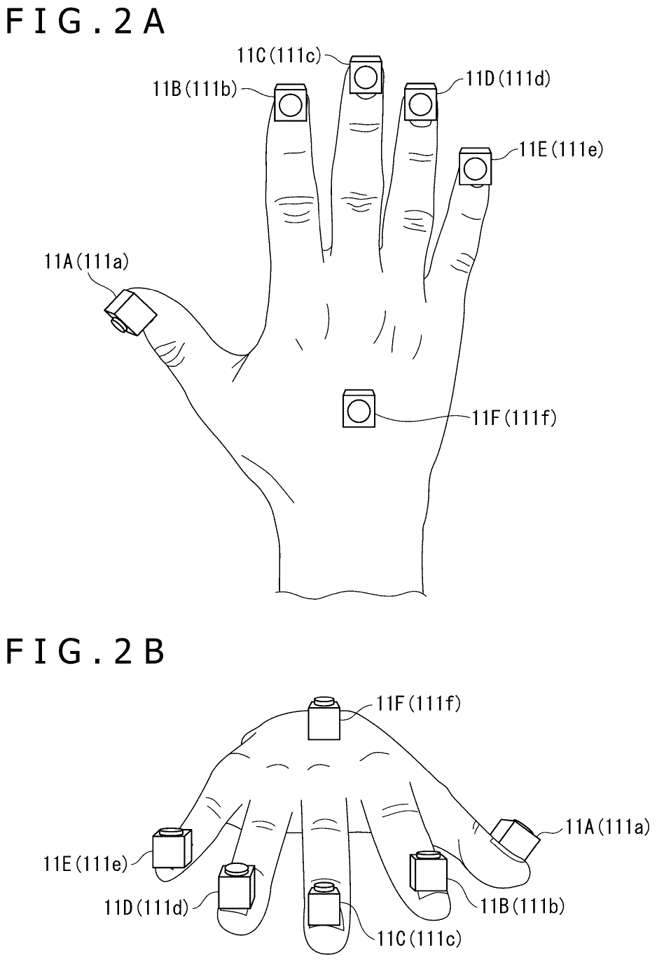

As depicted in FIG. 2A and FIG. 2B, the plurality of imaging sections 11A to 11F are provided at positions corresponding to the fingertips of the respective fingers and at positions on the nail side of the respective fingers. In more detail, for example, the imaging section 11A is provided for a first finger (thumb), and performs imaging by the sensor 111a to generate an image. Similarly, the imaging sections 11B, 11C, 11D, and 11E are provided for a second finger (index finger), a third finger (middle finger), a fourth finger (ring finger), and a fifth finger (little finger), respectively, and perform imaging by the sensors 111b, 111c, 111d, and 111e, respectively, to generate respective images. The imaging section F is provided at a position corresponding to the back of the hand, and performs imaging by the sensor 111f to generate an image.

In the present embodiment, any known sensor may be used for each of the sensors 111a to 111f. For example, each sensor may be an image sensor such as an RGB sensor for generating an image including color information, a depth sensor such as a time-of-flight (ToF) sensor and a light detection and ranging (LiDAR) sensor for generating an image including depth information, or a thermo-sensor for generating an image including temperature information.

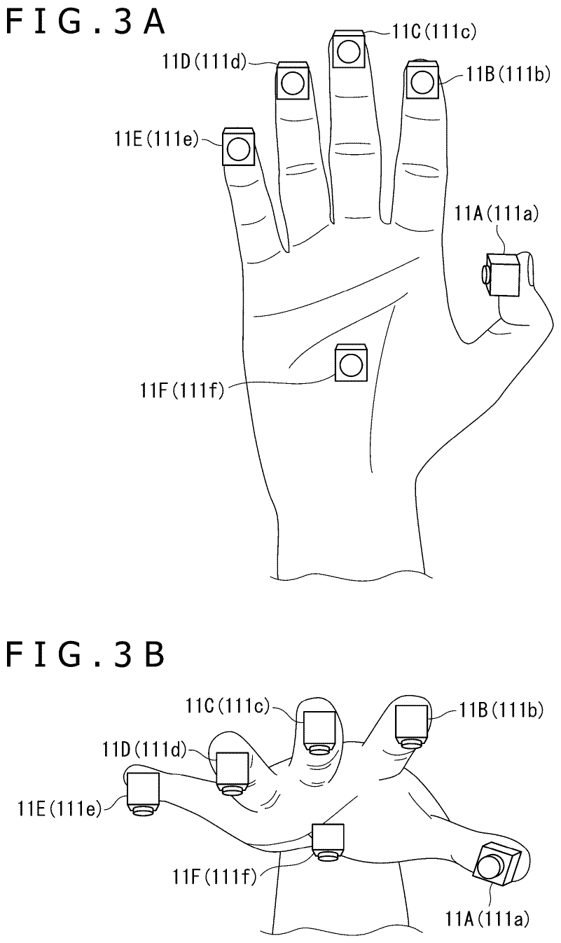

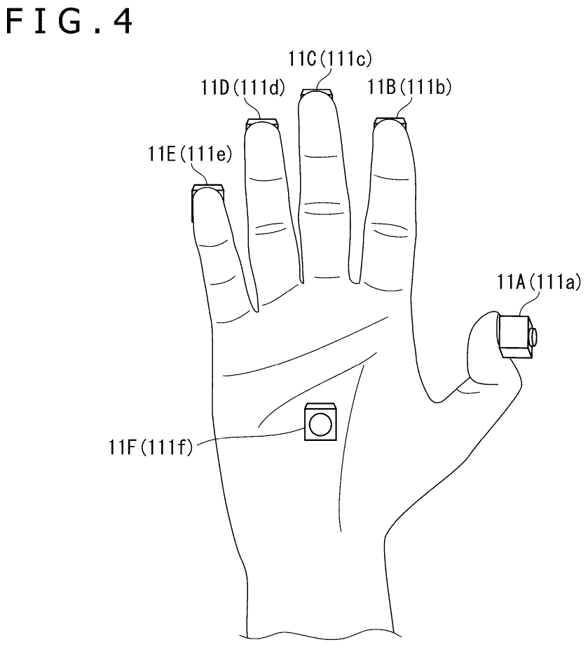

In addition, although it is preferable that the imaging sections 11A to 11F be arranged at positions corresponding to at least either joint parts or distal end parts of the hands and the fingers of the user, the arrangement positions of the imaging sections 11A to 11F are not limited to the examples of FIG. 2A and FIG. 2B. For example, although the examples in which the imaging sections 11A to 11E are provided on the nail side of the fingertips of the hands and the fingers are depicted in FIG. 2A and FIG. 2B, the imaging sections 11A to 11E may be provided on the ball side of the fingertips of the hands and the fingers as depicted in the examples of FIG. 3A and FIG. 3B. In addition, although the examples in which the imaging section 11F is provided at a position corresponding to the back of the hand of the hands and the fingers are depicted in FIG. 2A and FIG. 2B, the imaging section 11F may be provided at a position corresponding to the palm of the hand of the hands and the fingers as depicted in the examples of FIG. 3A and FIG. 3B and further depicted in the example of FIG. 4. The example of FIG. 4 depicts an example in which the imaging section 11F is provided at a position corresponding to the palm of the hand of the hands and the fingers and in which the imaging sections 11A to 11E are provided on the nail side of the fingertips of the hands and the fingers as in the examples of FIG. 2A and FIG. 2B.

In addition, imaging directions of the imaging sections 11A to 11F, that is, imaging directions of the sensors 111a to 111f that coincide with optical axis directions of the lenses, which are not illustrated, are preferably directions toward the outside from the center of the body of the user or distal end directions of the body, but the imaging directions of the imaging sections 11A to 11F are not limited to the above examples.

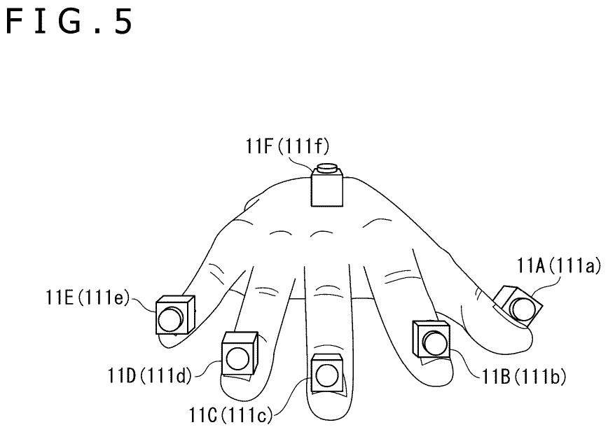

For example, the example in which the imaging directions of the imaging sections 11A to 11E are directions that coincide with movable directions of the respective fingers has been depicted above, but as depicted in the example of FIG. 5, the imaging directions of the imaging sections 11A to 11E may be directions orthogonal to the movable directions of the respective fingers, that is, directions that coincide with the distal end directions of the respective fingers.

Further, among the plurality of imaging sections, the imaging directions of some imaging sections and the imaging directions of the other imaging sections may be different from each other. For example, the imaging direction of the imaging section 11A provided for the first finger (thumb) may be a direction that coincides with the movable direction of each finger as in the examples of FIG. 2A and FIG. 2B, and the imaging directions of the imaging sections 11B, 11C, 11D, and 11E provided for the second finger (index finger), the third finger (middle finger), the fourth finger (ring finger), and the fifth finger (little finger), respectively, may be directions that coincide with the distal end directions of the respective fingers as in the example of FIG. 5.

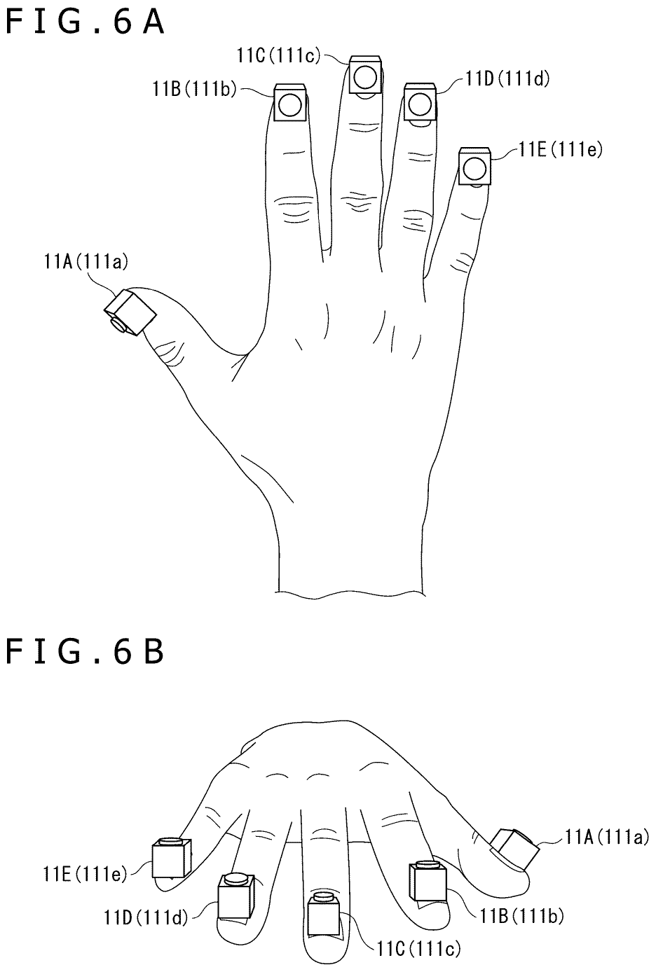

In addition, a configuration in which some of the imaging sections 11A to 11F are not provided may be adopted. For example, as depicted in the examples of FIG. 6A and FIG. 6B, there may be adopted a configuration in which the imaging sections 11A to 11F are provided at positions corresponding to the fingertips of the respective fingers as in the examples of FIG. 2A and FIG. 2B while the imaging sections are not provided at positions corresponding to the back of the hand and the palm of the hand unlike the examples of FIG. 2A and FIG. 2B. In addition, for example, there may be adopted a configuration in which the imaging sections 11A, 11B, and 11C for the first finger (thumb), the second finger (index finger), and the third finger (middle finger), respectively, are provided while the imaging sections are not provided for the fourth finger (ring finger) and the fifth finger (little finger).

In the present embodiment, the output section 12 may be provided for each of the imaging sections 11A to 11F, or one output section 12 for aggregating and outputting a plurality of images generated by the imaging sections 11A to 11F may be provided. In addition, the imaging sections 11A to 11F and the output section 12 may be connected to each other in a wired or wireless manner.

### Configuration of Information Processing Apparatus

Described with reference to FIG. 1 again, the information processing apparatus 20 includes a communication section 21 and a control section 22.

The communication section 21 receives information regarding a plurality of images generated by the imaging sections 11A to 11F of the operation apparatus 10 and output from the output section 12, and is connected to the display apparatus 30 in a wired or wireless manner.

The control section 22 includes each function of an estimation section 221, a correction value calculation section 222, and an image generation section 223 that are realized by a processor operating according to a program stored in a memory or received via a communication interface. The function of each section will be described later.

### Configuration of Display Apparatus

As depicted in FIG. 1, the display apparatus 30 includes a communication section 31, a control section 32, and a display section 33.

The communication section 31 is connected to the communication section 21 of the information processing apparatus 20 in a wireless or wired manner.

The control section 32 controls each section in the display apparatus 30.

For example, the display section 33 includes a display element such as a liquid crystal display (LCD) or an organic electroluminescent (EL) display.

In addition, the display apparatus 30 may also be a display apparatus for a wearable device such as a head-mounted display (HMD) unit, augmented reality (AR) glasses, or mixed reality (MR) glasses.

Next, the function of each section in the control section 22 of the information processing apparatus 20 will be described.

The estimation section 221 estimates the position and the posture of each of the plurality of imaging sections 11A to 11F of the operation apparatus 10 on the basis of a plurality of images acquired from the operation apparatus 10 via the communication section 21.

The plurality of images acquired from the operation apparatus 10 are images generated by the imaging sections 11A to 11F and mutually have a parallax. For example, the estimation section 221 creates a 3D map by mapping common feature points among feature points of surrounding objects and the like included in each image, and estimates the position and the posture of each of the imaging sections 11A to 11F on the basis of the created 3D map.

Detailed description of a specific method of such estimation processing is omitted because various known techniques can be used. As methods of the estimation processing, for example, visual odometry, visual simultaneous localization and mapping (SLAM), and the like can be mentioned.

In addition, a method of machine learning may be used for the estimation processing. Detailed description of a specific method of the machine learning is omitted because various known techniques can be used.

The correction value calculation section 222 calculates a correction value to be used for generating a model image. Details of the correction value will be described later.

The image generation section 223 controls a 3D model of the hands and the fingers on the basis of an estimation result obtained by the estimation section 221, adjusts the 3D model of the hands and the fingers on the basis of the correction value calculated by the correction value calculation section 222, and generates a model image on the basis of the adjusted 3D model.

More specifically, the image generation section 223 uses, for example, a known inverse kinetics (hereinafter, referred to as “IK”) technique to specify a start point (IK root), an end point (IK end), and a target point (IK goal) for a joint, so that a 3D model of skeletons (bones) of the hands and the fingers is controlled by making a posture correction for bending and stretching motion or the like. In the IK technique, when the tip end of a joint structure is moved, correction calculation is performed by tracing the rotation of the joint during the movement in an opposite direction (parent direction). Then, the image generation section 223 generates a model image by performing skinning processing for the 3D model to set the range of influence of the skeleton.

In a case where intermediate joints of the hands and the fingers in the model image are moved using the IK technique, it is desirable that the skeletons of the 3D model from which the model image is generated coincide with the skeletons of the hands and the fingers based on the estimation result obtained by the estimation section 221. For example, in a case where the hand of the 3D model is larger than the hand of the user operating the operation apparatus 10, the sensors (the sensors 111a to 111e) are inserted into the fingertips in the 3D model. In addition, in a case where the hand of the 3D model is smaller than the hand of the user operating the operation apparatus 10, the sensors (the sensors 111a to 111e) are located at positions away from the fingertips. In such cases, since the skeletons of the 3D model from which the model image is generated do not coincide with the skeletons of the hands and the fingers based on the estimation result obtained by the estimation section 221, there is a problem that bending of the intermediate joints is not correctly reproduced in the model image generated on the basis of the 3D model, the movement becomes unnatural, and the user feels a sense of strangeness.

Accordingly, in order to eliminate or reduce the above-described defect, the image generation section 223 adjusts the 3D model as necessary on the basis of the correction value calculated by the correction value calculation section 222, and then generates the model image.

Here, the calculation of the correction value by the correction value calculation section 222 is performed at least once in advance as what is generally called calibration processing.

The calculation of the correction value is performed on the basis of a reference image including the operation apparatus 10 itself in a field, that is, the field angle of the imaging apparatus. For example, the reference image may be generated by being captured by an operation apparatus that is mounted to a hand and fingers opposite to the hand and the fingers to which the operation apparatus 10 is mounted and that has a configuration similar to that of the operation apparatus 10. In this case, the user can generate the reference image by, for example, holding the other hand and fingers over the hand and the fingers to which the operation apparatus 10 is mounted. In addition, the reference image may be generated by an imaging apparatus provided in an apparatus other than the operation apparatus 10, such as an HMD, for example.

The correction value calculation section 222 acquires the reference image via the communication section 21, and calculates position information of feature points, such as joint information in the hands and the fingers of the user, from the reference image by using, for example, a method of machine learning. As the feature points, for example, an end point of each finger, a joint of each finger, a joint of a wrist, and the like can be mentioned. A learned model used for machine learning can be constructed in advance by, for example, executing supervised learning in which an image of hands and fingers of a person having a plurality of feature points is input data and coordinate information indicating the positions of the feature points in the hands and the fingers of the person is correct answer data.

It should be noted that detailed description of a specific method of the machine learning is omitted because various known techniques can be used. In addition, there may be adopted a configuration in which the correction value calculation section 222 is provided with a relation learning section and, each time the reference image is generated, the relation between the image based on the input reference image and the coordinate information indicating the positions of the feature points in the hands and the fingers of the person is learned to update a learned model.

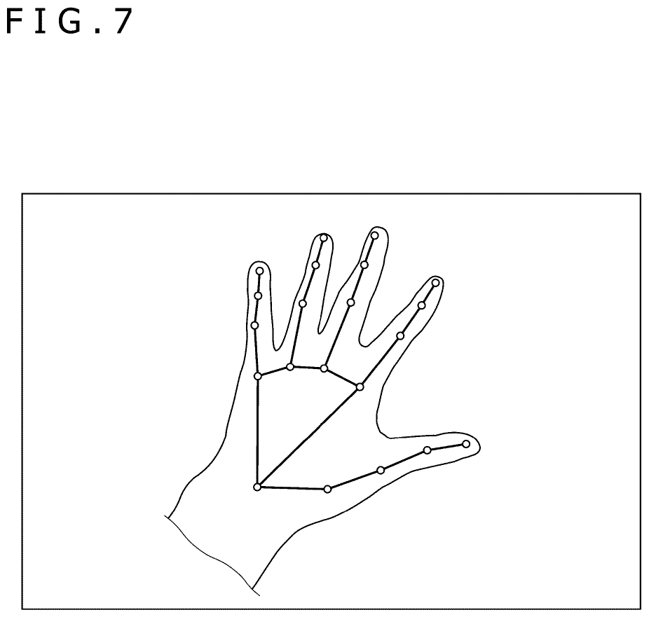

FIG. 7 exemplifies the feature points based on the reference image. In the example of FIG. 7, an end point of each finger, a joint of each finger, and a joint of a wrist are detected as the feature points, and the position information of each feature point is calculated. By generating the position information of the feature points in the hands and the fingers and obtaining the relative positional relation between these feature points, the actual lengths of the hands and the fingers of the user, the ratio of each part of the hands and the fingers, and the like can accurately be recognized.

In addition, the correction value calculation section 222 may extract the silhouette of the hands and the fingers of the user by using such a method as skin color detection for the reference image including color information, for example, and may generate the position information of the feature points in the hands and the fingers on the basis of the extracted silhouette.

In addition, the correction value calculation section 222 may generate the position information of the feature points in the hands and the fingers by, for example, estimating the thicknesses around the joints of the fingers and the like on the basis of depth information for the reference image including the depth information.

The image generation section 223 adjusts the lengths of the hands and the fingers and the ratio of each part of the hands and the fingers in the 3D model on the basis of the correction value. More specifically, the image generation section 223 adjusts the 3D model by enlarging or reducing the hands and the fingers in the 3D model, stretching or contracting the lengths of the hands and the fingers in the 3D model on the basis of the correction value, and changing the ratio of each part of the hands and the fingers in the 3D model on the basis of the correction value.

Then, the image generation section 223 generates a model image by performing skinning processing on the adjusted 3D model.

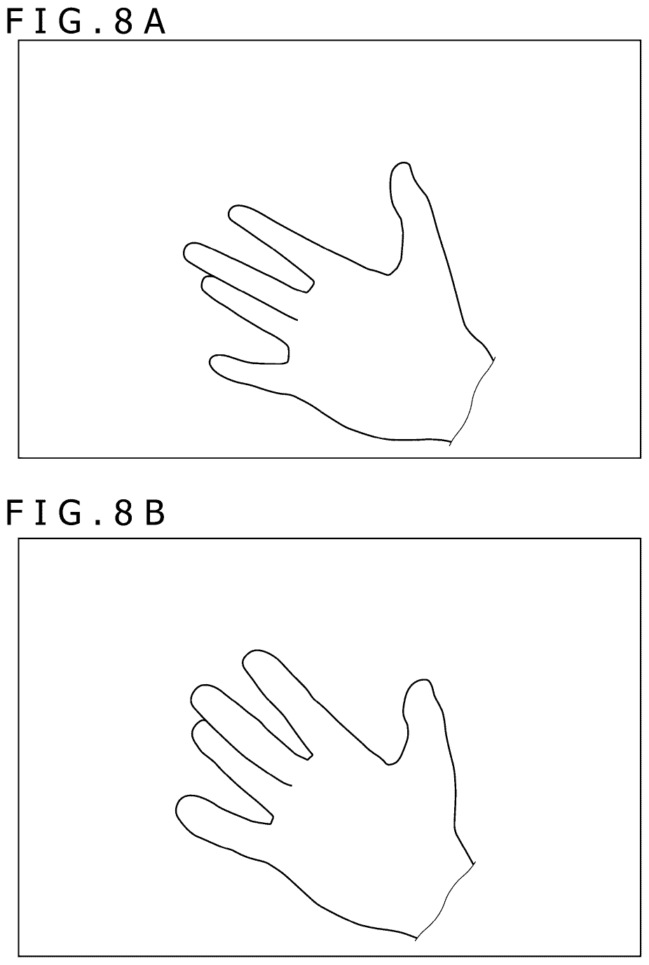

FIG. 8A depicts an example of a model image obtained before adjustment, and FIG. 8B depicts an example of a model image obtained after adjustment. In the example of FIG. 8B, the balance between the lengths of the respective fingers, the thickness of each finger, and the like in the 3D model are adjusted, and as a result, a model image close to the actual hands and fingers of the user, as compared with the example of FIG. 8A, is generated.

### Flow of Information Processing

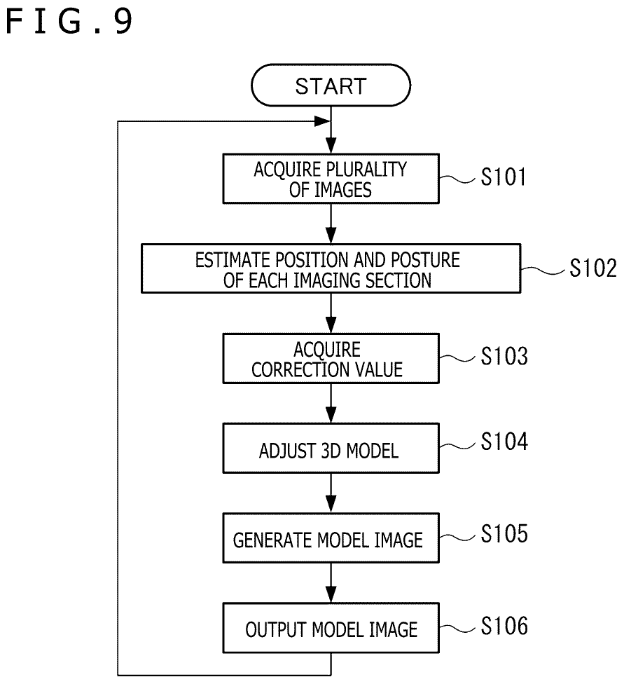

FIG. 9 is a flowchart for depicting processing executed by the control section 22.

The control section 22 acquires a plurality of images from the operation apparatus 10 via the communication section 21 (Step S101), and allows the estimation section 221 to estimate the position and the posture of each imaging section corresponding to each of the plurality of images (Step S102).

Then, the control section 22 acquires a correction value that is calculated in advance by the correction value calculation section 222 through calibration processing (Step S103), allows the image generation section 223 to adjust the 3D model according to the correction value (Step S104), and generates a model image (Step S105). Further, when the communication section 21 outputs the generated model image to the display apparatus 30 (Step S106), the flow returns to Step S101.

That is, each time a plurality of images are acquired from the operation apparatus 10, the processes of Steps S101 to S106 are repeatedly executed. Thus, each time a plurality of images are generated by the operation apparatus 10, a model image is output to the display apparatus 30, so that the model image displayed on the display section 33 is sequentially updated.

### Application Example 1

In a case where an operation apparatus having a configuration similar to that of the operation apparatus 10 is mounted to a hand and fingers opposite to the hand and the fingers to which the operation apparatus 10 is mounted, it is possible to directly track the imaging sections 11A to 11F of the operation apparatus 10 by holding the other hand and fingers over the hand and the fingers to which the operation apparatus 10 is mounted. In such a case, direct tracking processing may be performed instead of or in addition to a series of processing based on the plurality of images generated by the operation apparatus 10 described above.

For example, a series of processing based on the plurality of images generated by the operation apparatus 10 and direct tracking processing may be switched and performed in accordance with requests for the processing speed and processing accuracy. In addition, for example, the results of the series of processing based on the plurality of images generated by the operation apparatus 10 and the results of the direct tracking processing may complementarily be utilized.

Similarly, even in a case where an imaging apparatus provided in an apparatus other than the operation apparatus 10, such as an HMD, can image the hands and the fingers to which the operation apparatus 10 is mounted and generate an image, it is possible to directly track the imaging sections 11A to 11F of the operation apparatus 10. Even in such a case, the two types of processing may selectively be performed or may complementarily be performed.

### Application Example 2

Face part information may be calculated on the basis of a plurality of images generated by the imaging sections 11A to 11F of the operation apparatus 10.

For example, part information indicating the shapes, sizes, and positions of the parts configuring the face of the user may be calculated from the plurality of images generated by the imaging sections 11A to 11F, with use of such a method as feature point extraction.

Further, the image generation section 223 may generate a model image reflecting the shape of the face by using the information to reproduce the shapes, sizes, and positions of the parts of the face in the model image.

In addition, for example, mesh information and texture information of the hands and the fingers as well as the face may be calculated on the basis of the plurality of images generated by the imaging sections 11A to 11F of the operation apparatus 10.

For example, mesh information of the face of the user and texture information indicating the surface condition may be calculated from the plurality of images generated by the imaging sections 11A to 11F, with use of a method such as skin color detection. The texture information includes hue and texture of the skin of the user, and also includes irregularities of the surfaces of the hands and the fingers such as scars, moles, and wrinkles. Further, the image generation section 223 may use the information as texture for the face part in the model image or may reflect the hue and texture of the skin of the user and the irregularities of the surfaces of the hands and the fingers such as scars, moles, and wrinkles to generate a model image.

In addition, for example, texture information indicating the surface condition of the hands and the fingers of the user may be calculated in a similar manner from the plurality of images generated by the imaging sections 11A to 11F, to generate a model image. It should be noted that, in a case where images of both the palm side and the back side of the hand of the hands and the fingers of the user are imaged as the plurality of images generated by the imaging sections 11A to 11F, the images of the both sides can be adjusted even in the model image.

### Effects of First Embodiment

The operation apparatus 10 according to the first embodiment described above has the following effects. The operation apparatus 10 includes the mounting section that is not illustrated and is mounted to the body of a detection target, the plurality of imaging sections 11A to 11F that are provided in the mounting section and are arranged at positions corresponding to at least either joint parts or distal end parts of the body, and the output section 12 that outputs a plurality of images generated by the plurality of imaging sections 11A to 11F.

According to such a configuration, information for performing accurate tracking can be acquired without requiring such a configuration as that of an alternating current magnetic field generation apparatus and without requiring an imaging apparatus capable of imaging a detection target from the outside. Therefore, the configuration can suitably be used for a controller or the like in a virtual space.

The information processing apparatus 20 according to the first embodiment has the following effects.

The information processing apparatus 20 includes the communication section 21 that is an acquisition section which acquires a plurality of images generated by the operation apparatus 10 including the plurality of imaging sections 11A to 11F arranged at positions corresponding to at least either joint parts or distal end parts of a body and the estimation section 221 that estimates the position and the posture of each of the plurality of imaging sections 11A to 11F on the basis of the plurality of images. Therefore, accurate tracking can be performed without requiring such a configuration as that of an alternating current magnetic field generation apparatus and without requiring an imaging apparatus capable of imaging a detection target from the outside.

The information processing apparatus 20 includes the image generation section 223 that generates a model image that is a reproduction image reproducing the shape of the body, on the basis of an estimation result obtained by the estimation section 221. Therefore, the difference between the actual body and the model image can be reduced by precisely scaling the shape of the actual body of the detection target and making the model image correspond to the actual body of the detection target, and a sense of strangeness felt by the user can be reduced. As a result, reality and a sense of immersion can be improved, and a better experience can be provided to the user.

The information processing apparatus 20 includes the correction value calculation section 222 that calculates a correction value used for generating the reproduction image, the communication section 21 that is the acquisition section further acquires a reference image including the operation apparatus 10 itself in a field, the correction value calculation section 222 calculates a correction value according to the shape of the body on the basis of the reference image, and the image generation section 223 controls a 3D model of the body on the basis of the estimation result, adjusts the 3D model of the body on the basis of the correction value, and generates the reproduction image on the basis of the adjusted 3D model. Therefore, the movement of the body can correctly be reproduced in the model image by coinciding the skeleton of the 3D model from which the model image is generated with the skeleton based on the estimation result obtained by the estimation section 221.

### Second Embodiment

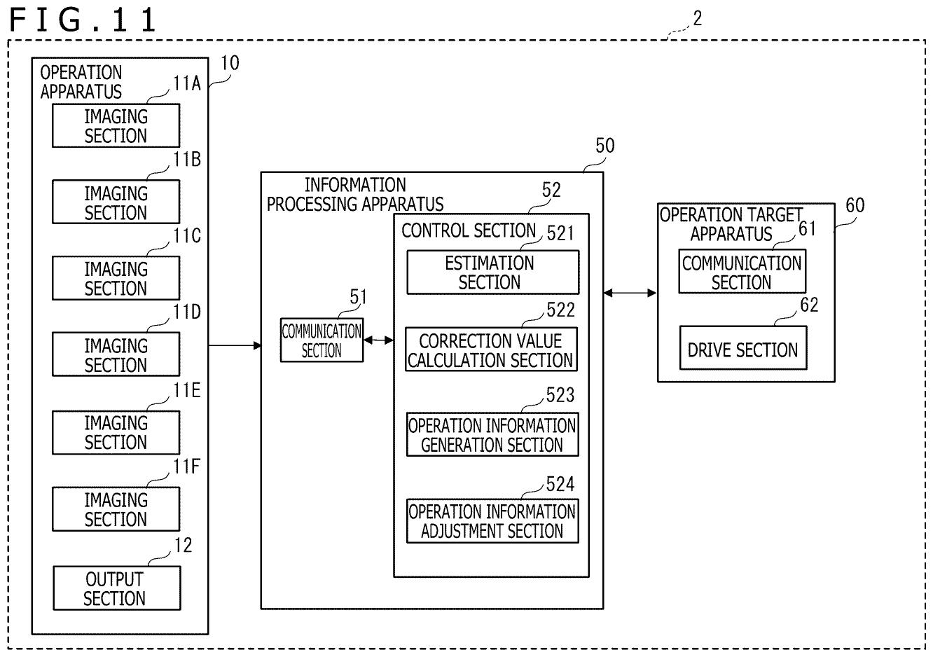

Hereinafter, a second embodiment of the present invention will be described with reference to the drawings. In the second embodiment, only the parts different from the first embodiment will be described, and description of the parts similar to the first embodiment will be omitted. In addition, in the second embodiment, constitutional elements having substantially the same functional configurations as those in the first embodiment are denoted by the same reference signs. FIG. 11 is a schematic diagram for depicting an entire information processing system according to the second embodiment of the present invention.

As depicted in FIG. 11, an information processing system 2 according to the second embodiment includes an information processing apparatus 50 and an operation target apparatus 60, instead of the information processing apparatus 20 and the display apparatus 30 of the information processing system 1 of the first embodiment. The information processing system 2 generates operation information in the information processing apparatus 50 according to an operation on the operation apparatus 10, and controls the operation target apparatus 60 on the basis of the operation information.

### Configuration of Information Processing Apparatus 50

As depicted in FIG. 11, the information processing apparatus 50 includes a communication section 51 and a control section 52.

The communication section 51 receives information regarding a plurality of images generated by the imaging sections 11A to 11F of the operation apparatus 10 and output from the output section 12. Further, the communication section 51 outputs the operation information generated by the control section 52 to the outside of the information processing apparatus 50 via wireless or wired communication. Details of the operation information will be described later.

The control section 52 includes each function of an estimation section 521, a correction value calculation section 522, an operation information generation section 523, and an operation information adjustment section 524 that are realized by a processor operating according to a program stored in a memory or received via a communication interface. Hereinafter, the function of each section will further be described.

Similarly to the estimation section 221 in the information processing apparatus 20 of the first embodiment, the estimation section 521 estimates the position and the posture of each of the plurality of imaging sections 11A to 11F of the operation apparatus 10 on the basis of the plurality of images acquired from the operation apparatus 10 via the communication section 31. The correction value calculation section 522 calculates a correction value used for adjusting the operation information. Details of the operation information and the correction value will be described later.

The operation information generation section 523 generates the operation information for operating the operation target apparatus 60 on the basis of the estimation result obtained by the estimation section 521. The operation information may be the detection result itself, or may be control information indicating the driving part and the driving amount of the operation target apparatus 60, which are calculated on the basis of the detection result.

Here, in a case where the difference between the actual hands and fingers of the user and the corresponding parts in the operation target apparatus 60 is large, a defect may occur in the operation of the operation target apparatus 60. For example, in a case where the sizes of the corresponding parts in the operation target apparatus 60 are largely different from the sizes of the actual hands and fingers of the user, an operation in the corresponding parts in the operation target apparatus 60 is not correctly reproduced in some cases.

That is, in a case where there is no difference between the actual hands and fingers of the user and the corresponding parts in the operation target apparatus 60 or the difference is sufficiently small, the actual movement of the hands and the fingers of the user is correctly reproduced in the operation target apparatus 60.

In order to eliminate or reduce the defect described above, the operation information adjustment section 524 adjusts the operation information generated by the operation information generation section 523, on the basis of the correction value generated by the correction value calculation section 522. A specific method of the adjustment will be described later.

### Configuration of Operation Target Apparatus 60

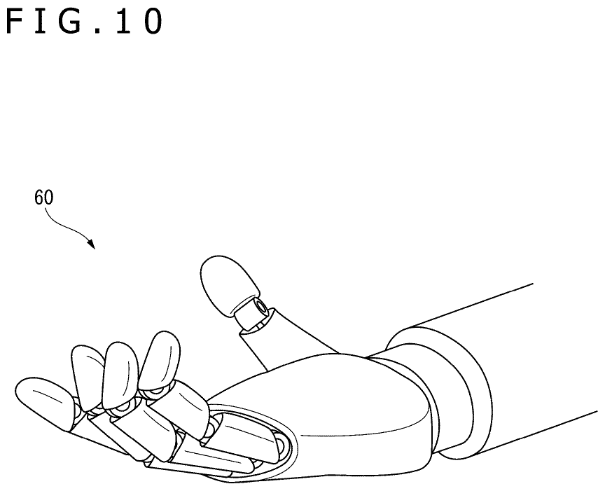

The operation target apparatus 60 is an apparatus operated according to an operation on the operation apparatus 10. As the operation target apparatus 60, for example, a robot hand, a manipulator, and the like can be mentioned. FIG. 10 depicts an example of the robot hand. As depicted in FIG. 11, the operation target apparatus 60 includes a communication section 61 and a drive section 62.

The communication section 61 receives the operation information output from the communication section 51 of the information processing apparatus 50.

The drive section 62 includes a plurality of motors such as servomotors and actuators according to the shapes of the robot hand and the manipulator, and drives at least one of them. At this time, the drive section 62 drives on the basis of the operation information (for example, a control signal for operating a servo motor) received via the communication section 61.

It should be noted that, for the drive section 62, the installation positions of the motors and actuators may be fixed or movable. For example, in a case where the operation target apparatus 60 is a robot hand, the motors and actuators of the drive section 62 installed at joint parts or the like of the robot hand may be fixed or movable. In any case, information indicating the installation positions of the motors and actuators in the drive section 62 of the operation target apparatus 60 is stored in advance in the control section 52 or can be acquired from the operation target apparatus 60 via the communication section 51. The same applies to a case where the operation target apparatus 60 is a manipulator.

### Adjustment of Operation Information

In a case where the installation positions of the motors and actuators in the drive section 62 of the operation target apparatus 60 are fixed, the operation information adjustment section 524 adjusts the operation information on the basis of the correction value. More specifically, the operation information adjustment section 524 first determines the correlation between the feature points in the correction value and the installation position of the drive section 62. Then, the operation information adjustment section 524 adjusts the operation information according to the correlation. That is, by adjusting the operation information to make the operation information correspond to the installation position of the drive section 62 in the operation target apparatus 60, the difference between the actual hands and fingers of the user and the installation positions of the motors and actuators in the drive section 62 of the operation target apparatus 60 is reduced.

On the other hand, in a case where the installation positions of the motors and actuators in the drive section 62 of the operation target apparatus 60 are movable, the operation information adjustment section 524 adjusts the operation information by adding adjustment information for enlarging or reducing the installation positions of the motors and actuators on the basis of the correction value, adjustment information for stretching or contracting the length between the installation positions of the motors and actuators on the basis of the correction value, adjustment information for changing the installation positions of the motors and actuators on the basis of the correction value, and the like to the operation information, similarly to the adjustment of the model image described in the first embodiment. That is, by adjusting the installation positions of the motors and actuators in the drive section 62 of the operation target apparatus 60 to the shapes of the actual hands and fingers of the user, the difference between the actual hands and fingers of the user and the installation positions of the motors and actuators in the drive section 62 of the operation target apparatus 60 is reduced.

### Flow of Information Processing

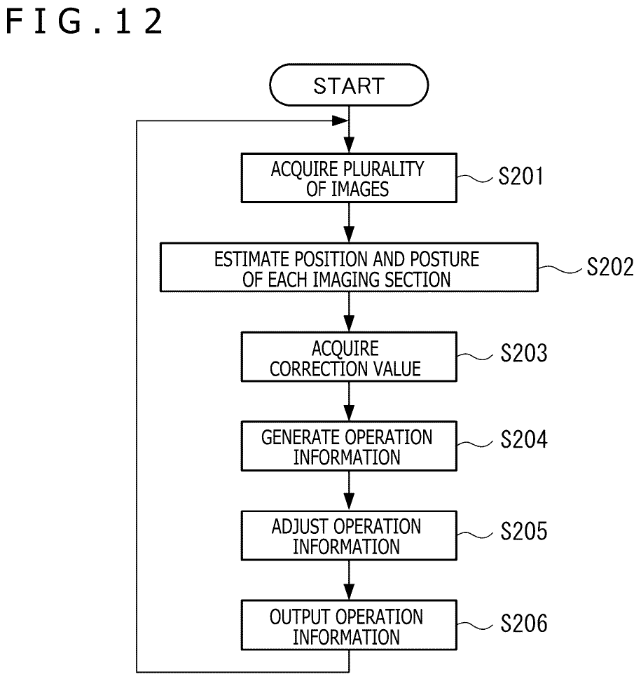

FIG. 12 is a flowchart for depicting processing executed by the control section 52 of the information processing apparatus 50.

The control section 52 acquires a plurality of images from the operation apparatus 10 via the communication section 51 (Step S201), and allows the estimation section 521 to estimate the position and the posture of each imaging section corresponding to each of the plurality of images (Step S202).

Then, the control section 52 acquires a correction value that is calculated in advance by the correction value calculation section 522 through calibration processing (Step S203), the operation information generation section 523 generates operation information (Step S204), and the operation information adjustment section 524 adjusts the operation information on the basis of the correction value (Step S205).

Further, when the communication section 51 outputs the adjusted operation information (Step S206), the flow returns to Step S201.

That is, each time a plurality of images are acquired from the operation apparatus 10, the processes of Steps S201 to S206 are repeatedly executed. Thus, the operation information is output each time a plurality of images are generated by the operation apparatus 10.

### Effects of Second Embodiment

The information processing system 2 according to the second embodiment described above has the following effects.

The information processing apparatus 50 includes the operation information generation section 523 that generates operation information for operating an operation target, on the basis of an estimation result obtained by the estimation section 521, and the operation information adjustment section 524 that adjusts the operation information.

According to such a configuration, information for accurately controlling the operation target can be acquired without requiring such a configuration as that of an alternating current magnetic field generation apparatus and without requiring an imaging apparatus capable of imaging a detection target from the outside.

The information processing apparatus 50 includes the correction value calculation section 522 that calculates a correction value used for adjusting the operation information and the operation information adjustment section 524 that adjusts the operation information, the communication section 51 that is an acquisition section further acquires a reference image including the operation apparatus 10 itself in a field, the correction value calculation section 522 calculates a correction value according to the shape of the body on the basis of the reference image, the operation information adjustment section 524 adjusts the operation information on the basis of the correction value, and the communication section 51 that is an operation information output section outputs the adjusted operation information to the operation target.

Therefore, the actual movement of the body can precisely be reproduced in the operation target by precisely scaling the shape of the actual body of the detection target and making the operation target correspond to the actual body of the detection target. Accordingly, it is possible to eliminate or reduce a defect in the operation of the operation target. In particular, it is possible to absorb individual differences in the shape of the body.

### Modifications of Embodiment

The present invention is not limited to each of the above-described embodiments, and modifications, improvements, and the like to the extent that the object of the present invention can be achieved are included in the present invention.

In the first embodiment and the second embodiment described above, the example in which the operation apparatus 10 is mounted to the hands and the fingers of the user has been depicted. However, the present invention is not limited thereto, and the operation apparatus 10 may be mounted to a position other than the hands and the fingers, for example, a joint part of the body such as a shoulder, an elbow, or a knee, or may be mounted to a distal end part of the body such as a head or a foot.

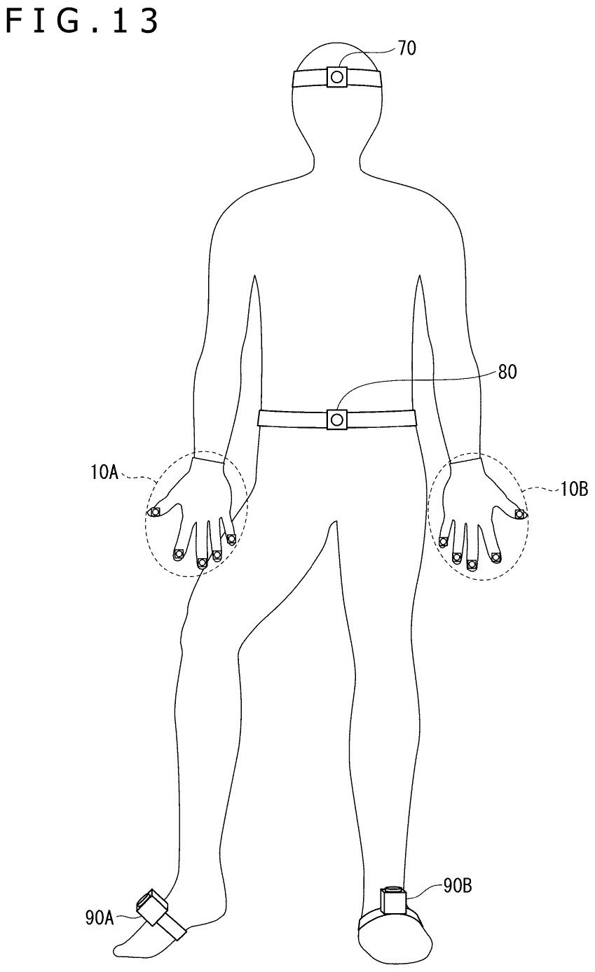

For example, FIG. 13 depicts an example in which operation apparatuses 10A and 10B similar to the operation apparatus 10 are mounted to the respective hands, operation apparatuses 70 and 80 similar to the operation apparatus 10 are mounted to the head and the abdomen, respectively, and operation apparatuses 90A and 90B similar to the operation apparatus 10 are mounted to the respective insteps of both feet. In the example depicted in FIG. 13, the operation apparatuses 70, 80, 90A, and 90B each include one imaging section. The arrangement and the number of operation apparatuses are not limited to this example, and it is preferable that the arrangement and the number of operation apparatuses be determined according to the purpose and application.

In addition, in the first embodiment and the second embodiment described above, the example in which the operation apparatus 10 is mounted to the body of the person who is the user has been depicted. However, the present invention is not limited thereto, and the operation apparatus 10 may be mounted to a body other than a person, for example, a body of an animal, a robot, or the like, in particular, a joint part or a distal end part.

In the first embodiment and the second embodiment described above, there may be adopted a configuration in which the imaging sections 11A to 11F are provided with a plurality of types of sensors. In this case, there may be adopted a configuration in which the outputs of the plurality of sensors are selectively or complementarily utilized. For example, in a case where an inertial measurement unit (IMU) sensor or the like is further mounted, the accuracy of position estimation can be expected to be improved. In addition, by a distance measuring sensor or the like being further mounted, the accuracy of depth estimation and the accuracy of size estimation can be expected to be improved.

There may be adopted a configuration in which a part of the processing performed by the information processing apparatus 20 in the first embodiment is performed by the operation apparatus 10 or other apparatuses. For example, there may be adopted a configuration in which some or all of the respective functions of the estimation section 221, the correction value calculation section 222, and the image generation section 223 in the information processing apparatus 20 of the first embodiment are performed by the operation apparatus 10. In addition, for example, there may be adopted a configuration in which the respective functions of the estimation section 221, the correction value calculation section 222, and the image generation section 223 in the information processing apparatus 20 of the first embodiment are performed by a plurality of information processing apparatuses.

A part of the processing performed by the information processing apparatus 50 in the second embodiment may be performed by the operation apparatus 10, the operation target apparatus 60, or other apparatuses. For example, there may be adopted a configuration in which some or all of the respective functions of the estimation section 521, the correction value calculation section 522, the operation information generation section 523, and the operation information adjustment section 524 in the information processing apparatus 50 of the second embodiment are performed by the operation apparatus 10. In addition, for example, there may be adopted a configuration in which some or all of the respective functions of the estimation section 521, the correction value calculation section 522, the operation information generation section 523, and the operation information adjustment section 524 in the information processing apparatus 50 of the second embodiment are performed by the operation target apparatus 60. In addition, for example, there may be adopted a configuration in which the respective functions of the estimation section 521, the correction value calculation section 522, the operation information generation section 523, and the operation information adjustment section 524 in the information processing apparatus 50 of the second embodiment are performed by a plurality of information processing apparatuses.

### SUMMARY OF PRESENT INVENTION

The summary of the present invention will hereinafter be additionally noted.
[1]

An operation apparatus including:
a mounting section that is mounted to a body of a detection target;
a plurality of imaging sections that are provided in the mounting section and are arranged at positions corresponding to at least either joint parts or distal end parts of the body; and
an output section that outputs a plurality of images generated by the plurality of imaging sections.
[2]

The operation apparatus according to [1],
in which imaging directions of at least some of the imaging sections among the plurality of imaging sections are directions toward an outside from a center of the body or distal end directions of the body.
[3]

The operation apparatus according to [1],
in which imaging directions of at least some of the imaging sections among the plurality of imaging sections are directions that coincide with or are orthogonal to movable directions of the imaging sections based on movement of the body.
[4]

The operation apparatus according to any one of [1] to [3],
in which at least some of the imaging sections among the plurality of imaging sections are provided at hands and fingers of the body in the mounting section.
[5]

The operation apparatus according to [4],
in which at least some of the imaging sections among the plurality of imaging sections are provided on a nail side or a ball side of fingertips of the hands and the fingers in the mounting section.
[6]

The operation apparatus according to [4] or [5],
in which at least some of the imaging sections among the plurality of imaging sections are provided at positions corresponding to backs of the hands or palms of the hands of the hands and the fingers in the mounting section.
[7]

An information processing apparatus including:
an acquisition section that acquires a plurality of images generated by an operation apparatus including a plurality of imaging sections arranged at positions corresponding to at least either joint parts or distal end parts of a body; and
an estimation section that estimates a position and a posture of each of the plurality of imaging sections on the basis of the plurality of images.
[8]

The information processing apparatus according to [7], further including:
an image generation section that generates a reproduction image reproducing a shape of the body, on the basis of an estimation result obtained by the estimation section.
[9]

The information processing apparatus according to [8], further including:
a correction value calculation section that calculates a correction value used for generating the reproduction image,
in which the acquisition section further acquires a reference image including the operation apparatus itself in a field,
the correction value calculation section calculates a correction value according to a shape of the body on the basis of the reference image, and
the image generation section controls a three-dimensional model of the body on the basis of the estimation result, adjusts the three-dimensional model of the body on the basis of the correction value, and generates the reproduction image on the basis of the adjusted three-dimensional model.
[10]

The information processing apparatus according to [7], further including:
an operation information generation section that generates operation information for operating an operation target, on the basis of an estimation result obtained by the estimation section; and
an operation information output section that outputs the operation information to the operation target.
[11]

The information processing apparatus according to [10], further including:
a correction value calculation section that calculates a correction value used for adjusting the operation information; and
an operation information adjustment section that adjusts the operation information,
in which the acquisition section further acquires a reference image including the operation apparatus itself in a field,
the correction value calculation section calculates a correction value according to a shape of the body on the basis of the reference image,
the operation information adjustment section adjusts the operation information on the basis of the correction value, and
the operation information output section outputs the adjusted operation information to the operation target.
[12]

An information processing system including:
an operation apparatus that includes a plurality of imaging sections arranged at positions corresponding to at least either joint parts or distal end parts of a body; and
the information processing apparatus according to any one of [7] to [11].
[13]

An information processing method including:
an acquisition procedure of acquiring a plurality of images generated by an operation apparatus including a plurality of imaging sections arranged at positions corresponding to at least either joint parts or distal end parts of a body; and
an estimation procedure of estimating a position and a posture of each of the plurality of imaging sections on the basis of the plurality of images.
[14]

An information processing program causing a computer to execute:
an acquisition step of acquiring a plurality of images generated by an operation apparatus including a plurality of imaging sections arranged at positions corresponding to at least either joint parts or distal end parts of a body; and
an estimation step of estimating a position and a posture of each of the plurality of imaging sections on the basis of the plurality of images.

### REFERENCE SIGNS LIST

1, 2: Information processing system
10: Operation apparatus
11A, 11B, 11C, 11D, 11E, 11F: Imaging section
12: Output section
20, 50: Information processing apparatus
21, 31, 51, 61: Communication section
22, 33, 52: Control section
30: Display apparatus
33: Display section
60: Operation target apparatus
62: Drive section
111a, 111b, 111c, 111d, 111e, 111f: Sensor
221, 521: Estimation section
222, 522: Correction value calculation section
223: Image generation section
523: Operation information generation section
524: Operation information adjustment section

1. An operation apparatus comprising:
a mounting section that is mounted to a body of a detection target;
a plurality of imaging sections that are provided in the mounting section and are arranged at positions corresponding to at least either joint parts or distal end parts of the body; and
an output section that outputs a plurality of images generated by the plurality of imaging sections.

2. The operation apparatus according to claim 1,
wherein imaging directions of at least some of the imaging sections among the plurality of imaging sections are directions toward an outside from a center of the body or distal end directions of the body.

3. The operation apparatus according to claim 1,
wherein imaging directions of at least some of the imaging sections among the plurality of imaging sections are directions that coincide with or are orthogonal to movable directions of the imaging sections based on movement of the body.

4. The operation apparatus according to claim 1,
wherein at least some of the imaging sections among the plurality of imaging sections are provided at hands and fingers of the body in the mounting section.

5. The operation apparatus according to claim 4,
wherein at least some of the imaging sections among the plurality of imaging sections are provided on a nail side or a ball side of fingertips of the hands and the fingers in the mounting section.

6. The operation apparatus according to claim 4,
wherein at least some of the imaging sections among the plurality of imaging sections are provided at positions corresponding to backs of the hands or palms of the hands of the hands and the fingers in the mounting section.

7. An information processing apparatus comprising:
an acquisition section that acquires a plurality of images generated by an operation apparatus including a plurality of imaging sections arranged at positions corresponding to at least either joint parts or distal end parts of a body; and
an estimation section that estimates a position and a posture of each of the plurality of imaging sections on a basis of the plurality of images.

8. The information processing apparatus according to claim 7, further comprising:
an image generation section that generates a reproduction image reproducing a shape of the body, on a basis of an estimation result obtained by the estimation section.

9. The information processing apparatus according to claim 8, further comprising:
a correction value calculation section that calculates a correction value used for generating the reproduction image,
wherein the acquisition section further acquires a reference image including the operation apparatus itself in a field,
the correction value calculation section calculates a correction value according to a shape of the body on a basis of the reference image, and
the image generation section controls a three-dimensional model of the body on the basis of the estimation result, adjusts the three-dimensional model of the body on a basis of the correction value, and generates the reproduction image on a basis of the adjusted three-dimensional model.

10. The information processing apparatus according to claim 7, further comprising:
an operation information generation section that generates operation information for operating an operation target, on a basis of an estimation result obtained by the estimation section; and
an operation information output section that outputs the operation information to the operation target.

11. The information processing apparatus according to claim 10, further comprising:
a correction value calculation section that calculates a correction value used for adjusting the operation information; and
an operation information adjustment section that adjusts the operation information,
wherein the acquisition section further acquires a reference image including the operation apparatus itself in a field,
the correction value calculation section calculates a correction value according to a shape of the body on a basis of the reference image,
the operation information adjustment section adjusts the operation information on a basis of the correction value, and
the operation information output section outputs the adjusted operation information to the operation target.

12. An information processing system comprising:
an operation apparatus that includes a plurality of imaging sections arranged at positions corresponding to at least either joint parts or distal end parts of a body; and
an information processing apparatus including
an acquisition section that acquires a plurality of images generated by the operation apparatus including the plurality of imaging sections arranged at the positions corresponding to at least either the joint parts or the distal end parts of the body, and
an estimation section that estimates a position and a posture of each of the plurality of imaging sections on a basis of the plurality of images.

13. An information processing method comprising:
acquiring a plurality of images generated by an operation apparatus including a plurality of imaging sections arranged at positions corresponding to at least either joint parts or distal end parts of a body; and
estimating a position and a posture of each of the plurality of imaging sections on a basis of the plurality of images.

14. An information processing program for a computer comprising:
by an acquisition section, acquiring a plurality of images generated by an operation apparatus including a plurality of imaging sections arranged at positions corresponding to at least either joint parts or distal end parts of a body; and
by an estimation section, estimating a position and a posture of each of the plurality of imaging sections on a basis of the plurality of images.
